(19) United States
(12) Patent Application Publication
(10) Pub. No.: US 2006/0154159 A1
(43) Pub. Date: Jul. 13, 2006

(54) Electrophotographic photoreceptor and electrophotographic imaging apparatus

(75) Inventors: An-kee Lim, Gunpo-si (KR); Kyung-yol Yon, Seongnam-si (KR); Ji-uk Kim, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/330,052

(22) Filed: Jan. 12, 2006

(30) Foreign Application Priority Data
Jan. 13, 2005 (KR) 10-2005-0003184

(51) Int. Cl. G03G 5/047

(52) U.S. Cl. 430/59.4; 430/58.4; 430/58.8; 430/78; 399/159

(57) ABSTRACT

The invention is directed to an electrophotographic photoreceptor, and an electrophotographic cartridge and an electrophotographic imaging apparatus including the electrophotographic photoreceptor. The electrophotographic photoreceptor includes: an electrically conductive substrate; a charge generating layer formed on the electrically conductive substrate and comprising μ-oxo-gallium phthalocyanine dimer as a charge generating material dispersed in a binder resin; and a charge transporting layer formed on the charge generating layer. The charge transporting layer includes a charge transporting material and a binder resin. The charge transporting material is a combination of (1) a butadiene-based amine compound and a hydrazone compound and (2) a combination of a first benzidine compound and a second benzidine compound. The amount of the charge transporting material is 5-200 parts by weight based on 100 parts by weight of the binder resin of the charge transporting layer. The electrophotographic photoreceptor has an excellent electrostatic property and a high interlayer adhesive force and resistance to abrasion and can be manufactured at a low cost.

### BACKGROUND OF THE INVENTION

This application claims the benefit of Korean Patent Application No. 10-2005-0003184, filed on Jan. 13, 2005, in the Korean Intellectual Property Office, the disclosure of which is hereby incorporated by reference in its entirety.

1. Field of the Invention

The present invention relates to an electrophotographic photoreceptor, and an electrophotographic imaging apparatus and an electrophotographic cartridge employing the electrophotographic photoreceptor. More particularly, the present invention relates to an electrophotographic photoreceptor having a high electrostatic property, interlayer adhesive force, and resistance to abrasion, and an electrophotographic imaging apparatus and an electrophotographic cartridge employing the electrophotographic photoreceptor.

2. Description of the Related Art

An electrophotographic photoreceptor is used in electrophotography, such as laser printers, photocopiers, CRT printers, facsimile machines, LED printers, liquid crystal printers, large flutters, laser electrophotos, and the like. The electrophotographic photoreceptor comprises a photosensitive layer formed on an electrically conductive substrate and is in the form of a plate, a disk, a sheet, a belt, a drum, and the like. In electrophotography, an image is formed using an electrophotographic photoreceptor as follows. First, a surface of the photosensitive layer is uniformly and electrostatically charged, and then the charged surface is exposed to a pattern of light, to form the latent image. The light exposure selectively dissipates the charge in the exposed regions where the light strikes the surface, thereby forming a pattern of charged and uncharged regions, referred to as a latent image. Then, a wet or dry toner is provided in the vicinity of the latent image, and toner droplets or particles deposit in either the charged or uncharged regions to form a toner image on the surface of the photosensitive layer. The resulting toner image can be transferred to a suitable ultimate or intermediate receiving surface, such as paper, or the photosensitive layer can function as the ultimate receptor for receiving the image. After that, a residual toner is cleaned and residual charges are erased from the electrophotographic photoreceptor. Thus, the electrophotographic photoreceptor can be repeatedly used for long periods.

Electrophotographic photoreceptors are generally categorized into two types. The first is a laminated-type having a laminated structure including a charge generating layer comprising a charge generating material (CGM), a binder resin, and other additives, and a charge transporting layer comprising a charge transporting material (primarily, a hole transporting material (HTM)), a binder resin, and other additives. In general, the laminated-type electrophotographic photoreceptor is used in the fabrication of a negative (−) type electrophotographic photoreceptor. The other type is a single layered-type in which a binder resin, a CGM, an HTM, and an electron transporting material (ETM) are contained in a single layer. In general, the single layered-type photoreceptor is used in the fabrication of a positive (+) type electrophotographic photoreceptor.

The laminated-type electrophotographic photoreceptor generally includes a metal substrate having a metal oxide layer or an insulating polymer layer on its surface and a charge generating layer and a charge transporting layer sequentially layered on the metal substrate. The charge generating layer generates an electric signal by light. The charge transporting layer transports the electric signal generated in the charge generating layer to a surface of the photoreceptor.

Examples of the CGM include photosensitive organic pigments and photosensitive inorganic pigments. The organic pigments such as azo pigments, perylene pigments, phthalocyanine pigments, are used rather than the inorganic pigments, since the organic pigments can have various crystalline structures according to synthesis methods and processing conditions, and thus, an electrostatic property of a photoreceptor can be easily modified. Among the organic pigments, phthalocyanine pigments, which are widely used as blue pigments for ink or coatings, are chemically and physically stable, and thus, commonly used as the CGM in an electrophotographic photoreceptor.

In general, for phthalocyanine compounds, UV light-visible light absorption spectrums, electrical properties, and thus properties of electrophotographic CGMs vary according to the types of center metal elements in phthalocyanine molecular structures, the crystal forms, and particle sizes. Many phthalocyanine-based CGMs, such as copper phthalocyanine, metal free phthalocyanine, chloro aluminum phthalocyanine, chloro indium phthalocyanine, chloro gallium phthalocyanine, chloro germanium phthalocyanine, oxobanadyl phthalocyanine, oxotitanyl phthalocyanine, hydroxy germanium phthalocyanine, hydroxy gallium phthalocyanine, and the like are known. These phthalocyanine compounds have various crystal forms. For example, copper phthalocyanine may have a ε-type crystal form. Metal free phthalocyanine may have an X, τ, τ′, or high purity X-type crystal form, a crystal form described in Japanese Laid-Open Patent Publication No. Sho 62-47054, a crystal form described in Japanese Laid-Open Patent Publication No. Hei 2-233769. Oxotitanyl phthalocyanine in a α, Y, I, A, C, B, or m-type crystal form, a quasi-amorphous crystal form described in Japanese Laid-Open Patent Publication No. Hei 1-123868, are suggested as an electrophotographic CGM. A simple mixture or a mixed crystal composition of at least two phthalocyanine compounds may be used an electrophotographic CGM. Japanese Laid-Open Patent Publication No. Sho 62-194257 describes using a mixture of oxotitanyl phthalocyanine with metal free phthalocyanine as a CGM. Japanese Laid-Open Patent Publication No. Hei 2-272067 describes a mixed crystal composition of oxotitanyl phthalocyanine and X-type metal free phthalocyanine. Japanese Laid-Open Patent Publication No. Hei 5-2278 describes a mixed crystal composition of oxotitanyl phthalocyanine and oxovanadyl phthalocyanine. Japanese Laid-Open Patent Publication No. Hei 6-234937 describes a mixed crystal composition of halogenated gallium phthalocyanine and metal free phthalocyanine. Japanese Laid-Open Patent Publication No. Hei 8-176455 describes a phthalocyanine composition comprising oxotitanyl phthalocyanine and a halogenated metal phthalocyanine in which a center metal is trivalent. Further, Japanese Laid-Open Patent Publication No. 2000-212462 and Japanese Laid-Open Patent Publication No. Sho 60-95441 describe a mixed crystal composition of a phthalocyanine compound and a phthalocyanine derivative.

Typically, the phthalocyanine-based CGMs are prepared as secondary particles having an average particle size of at least several microns in which primary particles are agglomerated to form the secondary particles. In order to use the phthalocyanine-based CGMs in the electrophotographic photoreceptor, the CGMs must be made of fine particulates. For this, a coating composition is obtained by dispersing a phthalocyanine-based CGM in an organic solvent and a binder resin. The coating composition is coated on an electrically conductive substrate and dried to form a charge generating layer.

It takes a long time to prepare the coating composition for the CGM particulates, and thus, if a large amount of the coating composition is prepared at once and then a portion of the coating composition is used when necessary, the production costs of the photoreceptor are reduced. However, when the coating composition is left for a predetermined time after the preparation, crystal transition, crystal growth and/or aggregation can occur in the CGM. Thus, when the charge generating layer is formed using a coating composition that is not fresh, an electrophotographic property of the photoreceptor is low and/or an electrical property of the photoreceptor is locally non-uniform. In this case, image defects, such as black points, image fogging, and the like, and a reduction in resolution can occur.

Thus, there is a need for a CGM which is more stable to crystal transition, crystal growth and/or aggregation than the conventional CGMs and a photoreceptor using the CGM.

Mechanical friction is frequently generated in the electrophotographic photoreceptor. When adhesive forces between the electrically conductive substrate, the charge generating layer, and the charge transporting layer are weak, the layers can be separated from each other, and the durability of the photoreceptor is decreased. Further, when the charge transporting layer has low resistance to abrasion, the photosensitivity and the image quality can be deteriorated and the photoreceptor cannot be used any more.

### SUMMARY OF THE INVENTION

The present invention provides an electrophotographic photoreceptor having high stability, electrophotographic property, and durability by using a charge generating material (CGM) which is more stable to crystal transition, crystal growth and/or aggregation than conventional CGMs.

The present invention also provides an electrophotographic cartridge comprising the electrophotographic photoreceptor.

The present invention also provides an electrophotographic imaging apparatus comprising the electrophotographic photoreceptor.

According to an aspect of the present invention, an electrophotographic photoreceptor is provided that comprises:
an electrically conductive substrate;
a charge generating layer formed on the electrically conductive substrate and comprising μ-oxo-gallium phthalocyanine dimer as a charge generating material dispersed in a binder resin; and
a charge transporting layer formed on the charge generating layer, the charge transporting layer comprising a charge transporting material dispersed or dissolved in a binder resin, the charge transporting material being selected from the group consisting of (1) a combination of a butadiene-based amine compound and a hydrazone compound and (2) a combination of a first benzidine compound and a second benzidine compound, wherein the charge transporting material is 5-200 parts by weight based on 100 parts by weight of the binder resin of the charge transporting layer.

According to another aspect of the present invention, an electrophotographic cartridge is provided that comprises:
an electrophotographic photoreceptor comprising:
   an electrically conductive substrate;
   a charge generating layer formed on the electrically conductive substrate and comprising μ-oxo-gallium phthalocyanine dimer as a charge generating material dispersed in a binder resin; and
   a charge transporting layer formed on the charge generating layer, the charge transporting layer comprising a charge transporting material dispersed or dissolved in a binder resin, the charge transporting material being selected from the group consisting of (1) a combination of a butadiene-based amine compound and a hydrazone compound and (2) a combination of a first benzidine compound and a second benzidine compound, wherein the amount of the charge transporting material is 5-200 parts by weight based on 100 parts by weight of the binder resin of the charge transporting layer; and
at least one device selected from the group consisting of:
a charging device for charging the electrophotographic photoreceptor;
a developing device for developing an electrostatic latent image formed on the electrophotographic photoreceptor; and
a cleaning device for cleaning a surface of the electrophotographic photoreceptor,
wherein the electrophotographic cartridge is attachable to or detachable from an imaging apparatus.

According to still another aspect of the present invention, an electrophotographic imaging apparatus is provided that comprises:
an electrophotographic photoreceptor comprising:
   an electrically conductive substrate;
   a charge generating layer formed on the electrically conductive substrate and comprising μ-oxo-gallium phthalocyanine dimer as a charge generating material dispersed in a binder resin; and
   a charge transporting layer formed on the charge generating layer, the charge transporting layer comprising a charge transporting material dispersed or dissolved in a binder resin, the charge transporting material being selected from the group consisting of (1) a combination of a butadiene-based amine compound and a hydrazone compound and (2) a combination of a first benzidine compound and a second benzidine compound, wherein the amount of the charge transporting material is 5-200 parts by weight based on 100 parts by weight of the binder resin of the charge transporting layer;
a charging device charging the electrophotographic photoreceptor;
an imageforming light irradiating device for irradiating light onto the charged electrophotographic photoreceptor to form an electrostatic latent image on the electrophotographic photoreceptor;
a developing unit for developing the electrostatic latent image with a toner to form a toner image on the electrophotographic photoreceptor; and
a transfer device for transferring the toner image onto a receptor.

The electrophotographic photoreceptor has a high electrostatic property due to the use of the μ-oxo-gallium phthalocyanine dimer and has a high interlayer adhesive force and resistance to abrasion due to the use of a specific binder resin and additives. Thus, by using the electrophotographic photoreceptor, an electrophotographic imaging apparatus, for example, an electrophotographic printer, a facsimile machine, a photocopier, or a plotter, have a reduced change in image with time after a long use, fewer image defects due to peeling or abrasion of the electrophotographic photoreceptor, and excellent performance. Further, the μ-oxo-gallium phthalocyanine dimer has the advantages of the high electrostatic property and high dispersion stability in the coating solution, thereby reducing the production costs of the electrophotographic photoreceptor.

These and other aspects of the invention will become apparent from the following detailed description of the invention which disclosed various embodiments of the invention.

### BRIEF DESCRIPTION OF THE DRAWINGS

These and other features and advantages of the present invention will become more apparent in view of the description of the exemplary embodiments with reference to the attached drawings in which:

FIG. 1 is a schematic illustration of an electrophotographic photoreceptor, an electrophotographic cartridge, and an imaging apparatus according to an embodiment of the present invention;

FIG. 2 is an X-ray diffraction diagram of μ-oxo-gallium phthalocyanine dimer which is used as a charge generating material (CGM) in an electrophotographic photoreceptor according to an embodiment of the present invention;

FIG. 3 is a cross-sectional view of an electrophotographic photoreceptor according to an embodiment of the present invention, the electrophotographic photoreceptor comprising an undercoat layer, a charge generating layer, and a charge transporting layer sequentially formed on an aluminum drum;

FIG. 4 is a cross-sectional view of an electrophotographic photoreceptor according to another embodiment of the present invention, the electrophotographic photoreceptor comprising an alumite layer, a charge generating layer, and a charge transporting layer sequentially formed on an aluminum drum; and

FIG. 5 is cross-sectional view of an electrophotographic photoreceptor according to still another embodiment of the present invention, the electrophotographic photoreceptor comprising an alumite layer, an undercoat layer, a charge generating layer, and a charge transporting layer sequentially formed on an aluminum drum.

### DETAILED DESCRIPTION OF THE INVENTION

An electrophotographic imaging apparatus, an electrophotographic cartridge, and the like, employing an electrophotographic photoreceptor according to an embodiment of the present invention will now be described in detail.

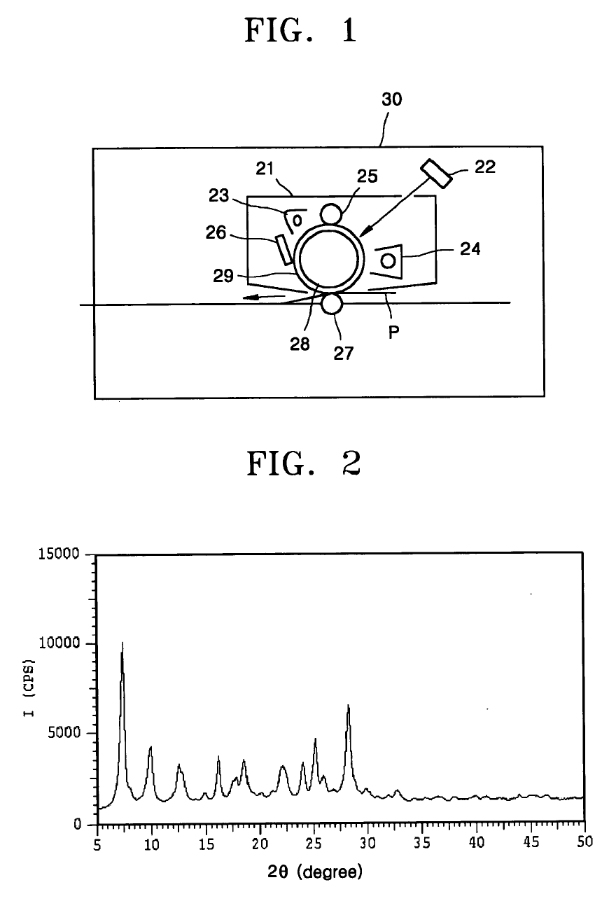

FIG. 1 is a schematic view an electrophotographic photoreceptor 29, an electrophotographic cartridge 21, and an imaging apparatus 30 according to an embodiment of the present invention.

In general, the electrophotographic cartridge 21 comprises the electrophotographic photoreceptor 29, at least one charging device 25 for charging the electrophotographic photoreceptor 29, a developing device 24 for developing an electrostatic latent image formed on the electrophotographic photoreceptor 29, and a cleaning device 26 for cleaning a surface of the electrophotographic photoreceptor 29. The electrophotographic cartridge 21 is attachable to or detachable from the imaging apparatus 30.

The electrophotographic photoreceptor 29 is disposed on a drum 28 to form the electrophotographic photoreceptor drum 28, 29. The electrophotographic photoreceptor drum 28, 29 is attachable to or detachable from the imaging apparatus 30.

Generally, the imaging apparatus 30 comprises the electrophotographic photoreceptor 29, a charging device 25 for charging the electrophotographic photoreceptor 29, an imageforming light irradiating device 22 for focusing and irradiating light onto the charged electrophotographic photoreceptor 29 to form an electrostatic latent image on the photoreceptor 29, a developing unit 24 for developing the electrostatic latent image with a toner to form a toner image on the photoreceptor 29, and a transfer device 27 for transferring the toner image onto a receptor, such as paper P. The charging device 25 may be supplied with a voltage from a charging unit and may charge the electrophotographic photoreceptor 29. The imaging apparatus 30 may further comprise a pre-exposure unit 23 for erasing the residual charge on the surface of the electrophotographic photoreceptor 29 to prepare for a next cycle.

The electrophotographic photoreceptor 29 according to an embodiment of the present invention can be incorporated into electrophotographic imaging apparatuses, such as laser printers, photocopiers, and facsimile machines.

Hereinafter, an electrophotographic photoreceptor according to an embodiment of the present invention is described in more detail.

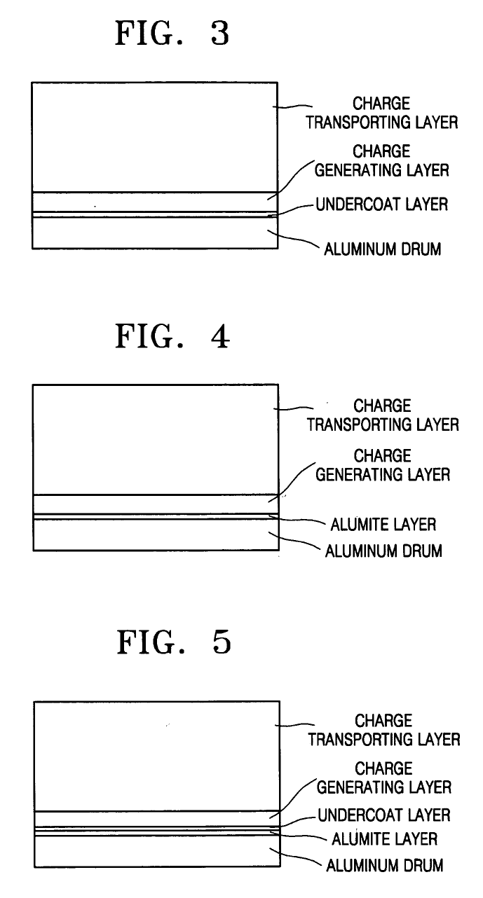

The electrophotographic photoreceptor comprises a photosensitive layer which is composed of a charge generating layer and a charge transporting layer sequentially formed on an electrically conductive substrate. The electrically conductive substrate can include an electrically conductive material, for example, metal and an electrically conductive polymer, or other electrically conductive material in the form of a plate, a disk, a sheet, a belt, a drum, or the like. Examples of the metal include aluminum, vanadium, nickel, copper, zinc, palladium, indium, tin, platinum, stainless steel, and chromium, or the like. Examples of the electrically conductive polymer include polyester resin, polycarbonate resin, polyamide resin, polyimide resin, a mixture thereof and a copolymer thereof, in which an electrically conductive material, such as electrically conductive carbon, tin oxide, indium oxide, is dispersed. Also, the electrically conductive substrate may be a metal sheet or an organic polymer sheet on which metal is deposited or laminated. In one embodiment, the electrically conductive substrate may be an aluminum substrate having an undercoat layer comprising metal oxide powders, such as TiO₂, dispersed in a binder resin such as polyamide, formed on its surface (FIG. 3), an aluminum substrate having a layer composed of alumite formed on its surface (FIG. 4), or an aluminum substrate having a layer composed of alumite and an undercoat layer comprising metal oxide powders, such as TiO₂, dispersed in a binder resin such as polyamide, sequentially formed on its surface (FIG. 5).

A charge generating material (CGM) used in the charge generating layer comprises μ-oxo-gallium phthalocyanine dimer. The μ-oxo-gallium phthalocyanine dimer has diffraction peaks at Bragg angles (2θ±2°) of about 7.4°, 9.9°, 12.5°, 13.0°, 15.0°, 16.2°, 17.5°, 17.9°, 18.6°, 22.2°, 24.1°, 25.2°, 25.9°, 26.9°, 28.3°, and 29.9° and has the strongest diffraction peak at a Bragg angle of about 7.4° in a powder X-ray diffraction diagram illustrated in FIG. 2. Since the μ-oxo-gallium phthalocyanine dimer has the highest sensitivity to light at a wavelength in the range of 780-800 nm, the μ-oxo-gallium phthalocyanine dimer can be effectively used in the present invention. The μ-oxo-gallium phthalocyanine dimer is highly dispersible in an organic solvent which is used in the production of a composition for forming the charge generating layer and thus, is present in the form of fine particles therein, thereby exhibiting a high photosensitivity in a small amount. The μ-oxo-gallium phthalocyanine dimer has high stability to crystal transition, crystal growth and/or aggregation, and accordingly, high dispersion stability for a long time. Thus, the composition for forming the charge generating layer can be prepared in a large amount at once, and then, a portion of the composition can be used when necessary. As a result, when the μ-oxo-gallium phthalocyanine dimer is used as the CGM, the costs of production of the electrophotographic photoreceptor may be reduced, since it takes a lot of time to perform milling, etc. when preparing the composition for forming the charge generating layer.

The μ-oxo-gallium phthalocyanine dimer is represented by Formula (1):

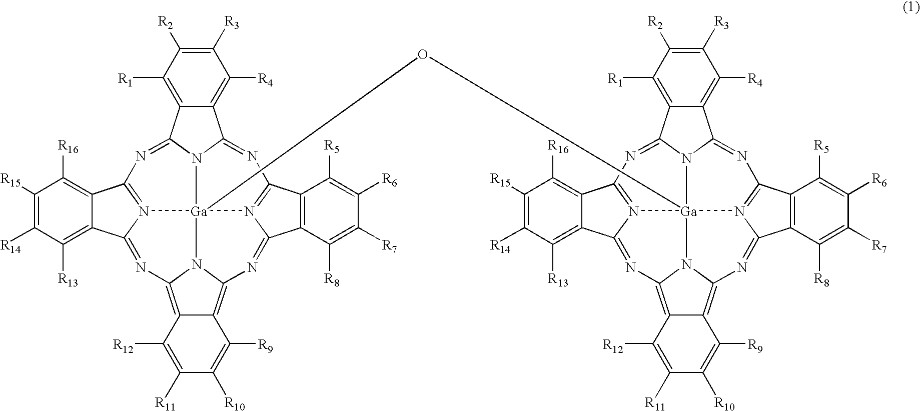

wherein
R₁ through R₁₆ are independently a hydrogen atom, a halogen atom, a nitro group, a substituted or unsubstituted C₁₋₃₀ alkyl group, or a substituted or unsubstituted C₁₋₃₀ alkoxy group.

The μ-oxo-gallium phthalocyanine dimer may be used together with other known CGMs, when required. Examples of these CGMs include, but are not limited to, other phthalocyanine compounds, an azo compound, a bisazo compound, a triazo compound, a quinone compound, a perylene compound, an indigo compound, a bisbenzoimidazole compound, an anthraquinone compound, a quinacridone compound, an azulenium compound, a squarylium compound, a pyrylium compound, a triarylmethane compound, a cyanine compound, a perynone compound, a polycycloquinone compound, a pyrrolopyrrole compound, or a naphthalocyanine compound. These CGMs may be added to the μ-oxo-gallium phthalocyanine dimmer alone or in a combination of two or more.

The μ-oxo-gallium phthalocyanine dimer is dispersed in a binder resin for producing the charge generating layer. Examples of the binder resin that may be used include, but are not limited to, polyvinyl butyral, polyvinyl acetal, polyester, polyamide, polyvinyl alcohol, polyvinyl acetate, polyvinyl chloride, polyurethane, polycarbonate, (meth)acryl resin, polyvinylidene chloride, polystyrene, styrene-butadiene copolymer, styrene-methyl methacrylate copolymer, vinylidene chloride-acrylonitrile copolymer, vinyl chloride-vinyl acetate copolymer, vinyl chloride-vinyl acetate-maleic anhydride copolymer, ethylene-acrylic acid copolymer, ethylene-vinyl acetate copolymer, methylcellulose, ethylcellulose, nitrocellulose, carboxymethyl cellulose, silicone resin, silicone-alkyd resin, phenol-formaldehyde resin, cresol-formaldehyde resin, phenoxy resin, styrene-alkyd resin, poly-N-vinylcarbazole resin, polyvinylformal, polyhydroxystyrene, polynorbornene, polycycloolefin, polyvinylpyrrolidone, poly(2-ethyl-oxazoline), polysulfone, melamine resin, urea resin, amino resin, isocyanate resin, epoxy resin, and the like. The binder resin may be used alone or in a combination of two or more.

The amount of the binder resin may be 5-350 parts by weight, preferably 10-200 parts by weight, based on 100 parts by weight of the CGM. If the amount of the binder resin is less than 5 parts by weight based on 100 parts by weight of the CGM, the phthalocyanine pigment cannot be uniformly dispersed and the obtained dispersion is less stable, and when the dispersion is coated on the electrically conductive substrate, a uniform charge generating layer cannot be obtained, and also, an adhesive force between the charge generating layer and the substrate can be reduced. If the amount of the binder resin is greater than 350 parts by weight based on 100 parts by weight of the CGM, a charging potential cannot be maintained and the photosensitivity of the charge generating layer is low, and thus a desired image quality cannot be obtained.

The solvent used in the production of the coating composition for the charge generating layer of the electrophotographic photoreceptor according to an embodiment of the present invention can vary according to the type of the binder resin used and, preferably, does not have an adverse effect on an adjacent layer when forming the charge generating layer. Specific examples of the solvent include methylisopropyl ketone, methylisobutyl ketone, 4-methoxy-4-methyl-2-pentanone, isopropylacetate, t-butyl acetate, isopropylalcohol, isobutyl alcohol, acetone, methylethyl ketone, cyclohexanone, 1,2-dichloroethane, 1,1,2-trichloroethane, 1,1,1-trichloroethane, trichloroethylene, tetrachloroethane, dichloromethane, tetrahydrofuran, dioxane, dioxolane, methanol, ethanol, 1-propanol, 1-butanol, 2-butanol, 1-methoxy-2-propanol, ethylacetate, butylacetate, dimethylsulfoxide, methylcellosolve, butylamine, diethylamine, ethylenediamine, isopropanolamine, triethanolamine, triethylenediamine, N,N′-dimethylformamide, 1,2-dimethoxyethane, benzene, toluene, xylene, methylbenzene, ethylbenzene, cyclohexane, and anisole. The solvent may be used alone or in a combination of two or more. The production of the coating solution for the charge generating layer will now be explained. First,100 parts by weight of l-oxo-gallium phthalocyanine dimer and 5-350 parts by weight, preferably 10-200 parts by weight, of the binder resin are mixed with an appropriate amount of the solvent, for example, 100-10,000 parts by weight, preferably 500-8,000 parts by weight. Glass beads, steel beads, zirconia beads, alumina beads, zirconia balls, alumina balls, or steel balls are added to the resultant mixture and dispersed for 2-50 hours using a disperser. In this case, a mechanical milling method may be used. Examples of a milling apparatus that can be used include an attritor, a ball-mill, a sand-mill, a Banbury mixer, a SBAC mixer, a roll-mill, a 3-roll mill, a nanomizer, a microfluidizer, a stamp mill, an oil mill, a vibrating mill, a kneader, a homonizer, Dinomill, a micronizer, a paint shaker, a high speed stirrer, an ultimizer, and a ultrasonic mill. The milling apparatus may be used alone or in a combination of two or more.

The coating composition for the charge generating layer thus prepared is coated on the electrically conductive substrate described above. Examples of the coating method include a dip coating, a ring coating, a roll coating, and a spray coating method. The coated electrically conductive substrate is dried at 90-200° C. for 0.1-2 hours to form a charge generating layer.

The thickness of the charge generating layer may be 0.001-10 μm, preferably 0.01-10 μm, more preferably 0.05-3 μm. If the thickness of the charge generating layer is less than 0.001 μm, the charge generating layer cannot be uniformly formed easily and the electrophotographic property can deteriorate.

Then, a charge transporting layer comprising a charge transporting material and a binder resin is layered on the charge generating layer.

The charge transporting material includes a hole transporting material (HTM) which transports holes and an electron transporting material (ETM) which transports electrons. When the laminated-type photoreceptor is to be negatively-charged, the HTM is used as the charge transporting material, and when the laminated-type photoreceptor is to have a bipolar property, i.e., to be positively/negatively-charged, a combination of the HTM and the ETM can be used as the charge transporting material.

The HTM that can be used in an embodiment of the present invention include a conventional HTM. Specific examples of the HTM include a nitrogen-containing cyclic compound or a condensed polycyclic compound, such as a hydrazone compound, a butadiene-based amine compound, a benzidine compound, a pyrene compound, a carbazole compound, an arylmethane compound, a thiazole compound, a styryl compound, a pyrazoline compound, an arylamine compound, an oxazole compound, an oxadiazole compound, a pyrazoline compound, a pyrazolone compound, a stilbene compound, a polyaryl alkane compound, a polyvinylcarbazole compound and a derivative thereof, N-acrylamidemethylcarbazole polymer, a triphenylmethane polymer, a styrene copolymer, polyacenaphthene, polyindene, a copolymer of acenaphthylene and styrene, and a formaldehyde-based condensed resin. Also, high molecular weight compounds or polysilane compounds having functional groups of the above compounds on a backbone or side chain may be used.

The ETM used in an embodiment of the present invention include a conventional ETM. Specific examples of the ETM include an electron attracting low-molecular weight compound such as a benzoquinone compound, a naphthoquinone compound, an anthraquinone compound, a malononitrile compound, a fluorenone compound, a cyanoethylene compound, a cyanoquinodimethane compound, a xanthone compound, a phenanthraquinone compound, an anhydrous phthalic acid compound, a thiopyrane compound, a dicyanofluorenone compound, a naphthalenetetracarboxylic acid diimide compound, a benzoquinoneimine compound, a diphenoquinone compound, a stilbene quinone compound, a diiminoquinone compound, a dioxotetracenedione compound, and a pyrane sulfide compound.

The charge transporting material that can be used in an embodiment of the present invention is not limited to the above HTM or ETM and may include a HTM or ETM having a degree of charge migration greater than 10⁻⁸ cm²/V sec. The above charge transporting material may be used alone or in a combination of two or more. The present inventors repeatedly performed experiments and discovered that when a combination of a butadiene-based amine compound and a hydrazone compound or a combination of a first benzidine compound and a second benzidine compound among the above charge transporting material is used as the charge transporting material, an electrophotographic photoreceptor with little change in image quality with time after a long time use and high photosensitivity can be obtained.

Since the butadiene-based amine compound has an excellent electrostatic property and thus, a low value of exposure energies (E_{1/2}, E₁₀₀) (thus high photosensitivity), and a low residual electric potential, it is suitable for a high sensitive charge transporting layer. However, the butadiene-based amine compound is expensive and can induce the change in image quality with time. Meanwhile, the hydrazone compound has a high value of E_{1/2} (poor photosensitivity) and a high residual electric potential. However, when the combination of the butadiene-based amine compound and the hydrazone compound is used, the change in image quality with time can decrease and the electrophotographic photoreceptor can stabilize, and also the production costs can decrease.

When the combination of the butadiene-based amine compound and the hydrazone compound is used, the mixing ratio is not specifically limited, but in order to optimize the electrostatic property and durability of the charge transporting layer and reduce the costs, a mixing ratio by weight of the butadiene-based amine compound:the hydrazone compound may be 100:5-250, preferably 100:5-200, and a mixing ratio by weight of the first benzidine compound:the second benzidine compound may be 100:5-300, preferably 100:5-200. When the combination of the first benzidine compound and the second benzidine compound is used as the charge transporting material, the first benzidine compound may be N,N′-bis-(3-methylphenyl)-N,N′-bis(phenyl)benzidine, and the second benzidine compound may be a compound selected from N,N,N′,N′-tetrakis(3-methylphenyl)benzidine, N,N,N′,N′-tetrakis(4-methylphenyl)benzidine, N,N′-di(naphthalene-1-yl)-N,N′-di(4-methylphenyl)benzidine, and N,N′-di(naphthalene-2-yl)-N,N′-di(3-methylphenyl)benzidine. Thus, the photosensitivity of the photoreceptor can be increased and the compatibility with the binder resin can be increased, thereby preventing the crystallization on a surface of the photoreceptor during the coating.

When a combination of a stilbene compound (5) and at least one of benzidine compounds (6) and (7) is used as the HTM, the photosensitivity can be increased. When a combination of the stilbene compound (5) and at least one of the butadiene-based amine compounds (1), (2), and (3) or a combination of the stilbene compound (5) and a hydrazone compound (4) is used as the HTM, the photosensitivity can be increased and the change in image quality with time can be suppressed. A mixing ratio by weight of the components in each of the above combinations is about the same as the mixing ratio of the butadiene-based amine compound and the hydrazone compound.

The above combinations of the HTMs are more effectively used when the μ-oxo-gallium phthalocyanine dimer is used as the CGM according to an embodiment of the present invention, than when oxotitanyl phthalocyanine is used the CGM.

Specific examples of the butadiene-based amine compound include the following compounds (1), (2), and (3). Specific examples of the hydrazone compound include the following compound (4). Specific examples of the stilbene compound include the following compound (5). Specific examples of the benzidine compound include the following compounds (6) and (7).

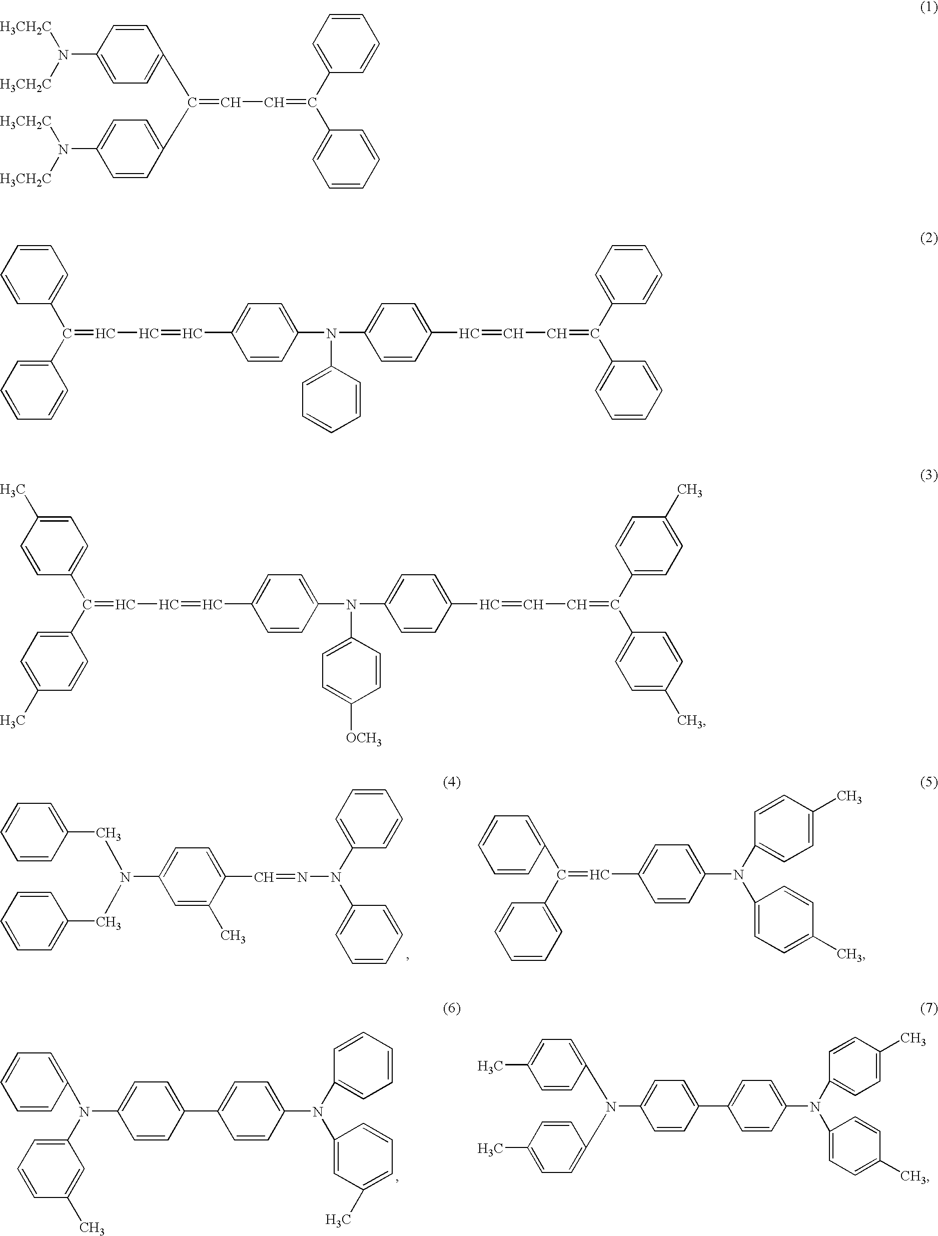

When the charge transporting material is capable of forming a film, the charge transporting layer can be formed without the binder resin, but the low molecular weight material generally does not have the film forming ability. Thus, the charge transporting material is dissolved or dispersed in the binder resin to obtain a composition for the charge transporting layer in the form of a solution or a dispersion. Then, the composition is coated on the charge generating layer and dried, thereby forming the charge transporting layer. Examples of the binder resin that can be used in the charge transporting layer include an insulating resin having the film forming ability, such as polyvinyl butyral, polyarylate (for example, a condensation polymer of bisphenol A and phthalic acid, etc.), polycarbonate, polyester resin, phenoxy resin, polyvinyl acetate, acrylic resin, polyacrylamide resin, polyamide, polyvinyl pyridine, cellulose-based resin, urethane resin, epoxy resin, silicone resin, polystyrene, polyketone, polyvinyl chloride, vinyl chloride-acrylic acid copolymer, polyvinyl acetal, polyacrylonitrile, phenolic resin, melamine resin, casein, polyvinyl alcohol, or polyvinylpyrrolidone, and an organic photoconductive resin such as poly N-vinylcarbazole, polyvinylanthracene, or polyvinylpyrene.

The present inventors discovered that it is preferable that the binder resin for the charge transporting layer is a polycarbonate resin, particularly polycarbonate-Z derived from cyclohexylidene bisphenol, rather than polycarbonate-A derived from bisphenol A or polycarbonate-C derived from methyl bisphenol A, since the polycarbonate-Z has a higher glass transition temperature and is more resistant to abrasion. The amount of the charge transporting material may be 5-200 parts by weight, preferably 10-150 parts by weight, based on 100 parts by weight of the binder resin.

The charge transporting layer of the electrophotographic photoreceptor according to an embodiment of the present invention may comprise a phosphate compound, a phosphine oxide compound, or a mixture thereof, and silicone oil, in order to increase the resistance to abrasion of the charge transporting layer and provide smoothness (=slip property) to a surface of the charge transporting layer. Specific examples of the phosphate compound include, but are not limited to, triphenyl phosphate, tricresyl phosphate, trioctyl phosphate, octyldiphenyl phosphate, trichloroethyl phosphate, cresyldiphenyl phosphate, tributyl phosphate, and tri-2-ethylhexyl phosphate. Specific examples of the phosphine oxide compound include, but are not limited to, triphenyl phosphine oxide, tricresyl phosphine oxide, trioctyl phosphine oxide, octyldiphenyl phosphine oxide, trichloroethyl phosphine oxide, cresyldiphenyl phosphine oxide, tributyl phosphine oxide, and tri-2-ethylhexyl phosphine oxide.

The phosphate compound and the phosphine oxide compound may be used in a combination of two or more. The amount of the phosphate compound, the phosphine oxide compound, or the mixture thereof may be 0.01-10 parts by weight, preferably 0.1-5 parts by weight, based on 100 parts by weight of the binder resin of the charge transporting layer. If the amount is less than 0.01 parts by weight based on 100 parts by weight of the binder resin of the charge transporting layer, the adhesive force and resistance to abrasion cannot be sufficiently increased. If the amount is greater than 10 parts by weight based on 100 parts by weight of the binder resin of the charge transporting layer, the electrostatic property can be decreased. When the phosphate compound and the phosphine oxide compound are used in combination, a mixing ratio by weight of the phosphate compound:the phosphine oxide compound may be 100:0.1-100.

The silicone oil increases the slip property of the charge transporting layer, thereby increasing the resistance to abrasion of the electrophotographic photoreceptor. Examples of the silicone oil that can be used include, but are not limited to, straight silicone oil, such as polysiloxane oil, for example, dimethylsilicone oil, methylphenyl silicone oil, methylhydrogen silicone oil; and modified silicone oil which has an organic group introduced in at least one position of side chains and end groups of the above straight silicone oil. Examples of the organic group include an amino group, an epoxy group, a carboxyl group, an alcohol group, a mercapto group, an alkyl group, a polyether group, a methylstyryl group, a high fatty acid ester group, a fluorinated alkyl group, a (meth)acryl group, and an alkoxy group. Specific examples include trade names KF96, KF50, KF54, KP301, KP302, KP306, KP321, KP322, KP323, KP324, KP326, KP340, KP341, KP354, KP355, KP356, KP357, KP358, KP359, KP362, KP363, KP365, KP366, KP368, KP369, KP316, KP360, KP361, KP390, KP391, and KP392, available from Shinetsu Chemical Co., Ltd., Japan.

The amount of the silicone oil may be 0.01-1 parts by weight, preferably of 0.01-0.5 parts by weight, based on 100 parts by weight of the binder resin of the charge transporting layer. If the amount of the silicone oil is less than 0.01 parts by weight based on 100 parts by weight of the binder resin of the charge transporting layer, the slip property cannot be easily increased. If the amount of the silicone oil is greater than 1 part by weight based on 100 parts by weight of the binder resin of the charge transporting layer, the adhesive force of the charge transporting layer can be decreased. When the phosphate compound and/or the phosphine oxide compound and the silicone oil are used together in forming the charge transporting layer, the slip property of the surface of the charge transporting layer can be increased, thereby increasing the resistance to abrasion.

A solvent used in the production of the coating solution for the charge transporting layer of the electrophotographic photoreceptor according to an embodiment of the present invention can vary according to the type of the binder resin used and, preferably, does not have an adverse effect on the charge generating layer disposed under the charge transporting layer. Specific examples of the solvent include aromatic hydrocarbons, such as benzene, xylene, ligroin, monochlorobenzene, and dichlorobenzene; ketones, such as acetone, methylethyl ketone, and cyclohexanone; alcohols, such as methanol, ethanol, and isopropanol; esters, such as ethyl acetate and methyl cellosolve; halogenated aliphatic hydrocarbons, such as carbon tetrachloride, chloroform, dichloromethane, dichloroethane, and trichloroethylene; ethers, such as tetrahydrofuran, dioxane, dioxolane, ethylene glycol, and monomethyl ether; amides, such as N,N-dimethyl formamide and N,N-dimethyl acetamide; and sulfoxides, such as dimethylsulfoxide. The solvent may be used alone or in a combination of two or more.

The production of the coating solution for the charge transporting layer will now be explained. First, 100 parts by weight of the binder resin, 5-200 parts by weight of the charge transporting material, 0.01-10 parts by weight of the phosphate compound and/or the phosphine oxide compound, and 0.01-1 parts by weight of the silicone oil are mixed with an appropriate amount of the solvent, for example, 100-1,500 parts by weight, preferably 300-1,200 parts by weight, and then the resultant mixture is stirred.

The coating composition for the charge transporting layer thus prepared is coated on the charge generating layer. Examples of the coating method include a dip coating, a ring coating, a roll coating, and a spray coating method, as described above. The coated substrate is dried at 90-200° C. for 0.1-2 hours to form the charge transporting layer.

The thickness of the charge transporting layer may be 2-100 μm, preferably 5-50 μm, more preferably 10-40 μm. If the thickness of the charge transporting layer is less than 2 μm, the durability of the charge transporting layer is decreased. If the thickness of the charge transporting layer is greater than 100 μm, a printed image quality is decreased.

In the production of the photoreceptor according to an embodiment of the present invention, an electron accepting material may be further added to the charge transporting layer and/or the charge generating layer, in order to increase the photosensitivity, decrease the residual electric potential and/or decrease fatigue during the repeated use. Examples of the electron accepting material include, but are not limited to, a compound having a high electron affinity, such as succinic acid anhydride, maleic acid anhydride, dibromosuccinic acid anhydride, phthalic acid anhydride, 3-nitrophthalic acid anhydride, 4-nitrophthalic acid anhydride, pyromellitic acid anhydride, pyromellitic acid, trimellitic acid, trimellitic acid anhydride, phthalimide, 4-nitro phthalimide, tetracyanoethylene, tetracyanoquinodimethane, chloranyl, bromanyl, o-nitrobenzoic acid, and p-nitrobenzoic acid. The amount of the electron accepting material may be 0.01-100% by weight based on a weight of the CGM.

A deterioration inhibitor, for example, an antioxidant or a photostabilizer, may be contained in the photoreceptor according to an embodiment of the present invention, in order to increase resistance to the environment and increase stability to harmful light. Examples of the compound that can be used for these purposes include a chromanol derivative, such as tocopherol, and its ether or ester compound, a polyaryl alkane compound, a hydroquinone derivative and its mono- and diether compound, a benzophenone derivative, a benzotriazole derivative, an ether sulfide compound, a phenylenediamine derivative, phosphonic acid ester, phosphorous acid ester, a phenol compound, a sterically hindered phenol compound, a linear amine compound, a cyclic amine compound, and a sterically hindered amine compound.

Hereinafter, the present invention will be described in more detail with reference to the following examples. However, these examples are given for the purpose of illustration and are not intended to limit the scope of the invention.

### EXAMPLES

### Example 1

7 parts by weight of μ-oxo-gallium phthalocyanine dimer (GPL-G, available from Orient Chemical Industries, Japan), 3.5 parts by weight of polyvinylbutyral resin (ESREC BH-3, available from Sekisui Co., Ltd.), and 100 parts by weight of 1,2-dimethoxyethane were ball milled for 48 hours together with 300 parts by weight of glass beads. The resultant dispersion was diluted with 400 parts by weight of 1,2-dimethoxyethane and treated with ultrasonic waves for 30 minutes to prepare a stable coating solution for forming a charge generating layer. The coating solution was uniformly coated on an aluminum drum having an alumite layer using a dip coating method, and then dried at 150° C. for 1 hour to form a charge generating layer.

4 parts by weight of 4-dibenzylamino-2-methylbenzaldehyde diphenylhydrazone (CTC-191, available from Takasago International Corporation, compound (4)), 4 parts by weight of 1,1-bis-(p-diethylaminophenyl)-4,4-diphenyl-1,3-butadiene (T405, available from Takasago International Corporation, compound (1)), 11 parts by weight of polycarbonate (PCZ400, available from Mitsubishi Gas Chemical Company), 0.3 parts by weight of n-octadecyl-3-(3,5-ditertiarybutyl-4-hydroxyphenyl)propionate, 0.04 parts by weight of trioctyl phosphate, 0.004 parts by weight of a silicone oil (KF-50, available from Shinetsu Chemical Co., Ltd.), 60 parts by weight of tetrahydrofuran, and 20 parts by weight of toluene were stirred together to obtain a solution. The resultant solution was coated on the charge generating layer of the drum to form a charge transporting layer, and the drum was dried at 150° C. for 1 hour. The electrostatic property and the durability of the electrophotographic photoreceptor drum were measured using the methods explained below. The results are shown in Table 1.

### Example 2

An electrophotographic photoreceptor was manufactured in the same manner as in Example 1, except that bis(p-4,4-diphenyl-1,3-butadienephenyl)phenylamine (compound (2)) was used in the charge transporting layer, instead of 1,1-bis-(p-diethylaminophenyl)-4,4-diphenyl-1,3-butadiene (compound (1)). The electrostatic property and the durability of the electrophotographic photoreceptor were estimated and the results are shown in Table 1.

### Example 3

An electrophotographic photoreceptor was manufactured in the same manner as in Example 1, except that bis(p-4,4-di-p-methylphenyl-1,3-butadienephenyl)phenyl-p-methoxyphenylamine (compound (3)) was used in the charge transporting layer, instead of 1,1-bis-(p-diethylaminophenyl)-4,4-diphenyl-1,3-butadiene (compound (1)). The electrostatic property and the durability of the electrophotographic photoreceptor were estimated and the results are shown in Table 1.

### Example 4

An electrophotographic photoreceptor was manufactured in the same manner as in Example 1, except that 4-(2,2-bisphenyl-ethene-1-yl)-4′,4″-dimethyl-triphenylamine (compound (5)) was used in the charge transporting layer, instead of 1,1-bis-(p-diethylaminophenyl)-4,4-diphenyl-1,3-butadiene (compound (1)). The electrostatic property and the durability of the electrophotographic photoreceptor were estimated and the results are shown in Table 1.

### Example 5

An electrophotographic photoreceptor was manufactured in the same manner as in Example 1, except that 6 parts by weight of N,N′-bis-(3-methylphenyl)-N,N′-bis(phenyl)benzidine (compound (6)) and 2 parts by weight of N,N,N′,N′-tetrakis(4-methylphenyl)benzidine (compound (7)) were used in the charge transporting layer, instead of 4 parts by weight of 4-dibenzylamino-2-methylbenzaldehydediphenylhydrazone (compound (4)) and 4 parts by weight of 1,1-bis-(p-diethylaminophenyl)-4,4-diphenyl-1,3-butadiene (compound (1)). The electrostatic property and the durability of the electrophotographic photoreceptor were estimated and the results are shown in Table 1.

### Example 6

An electrophotographic photoreceptor was manufactured in the same manner as in Example 1, except that 6 parts by weight of N,N′-bis-(3-methylphenyl)-N,N′-bis(phenyl)benzidine (compound (6)) and 2 parts by weight of 4-(2,2-bisphenyl-ethene-1-yl)-4′,4″-dimethyl-triphenylamine (compound (5)) were used in the charge transporting layer, instead of 4 parts by weight of 4-dibenzylamino-2-methylbenzaldehydediphenylhydrazone (compound (4)) and 4 parts by weight of 1,1-bis-(p-diethylaminophenyl)-4,4-diphenyl-1,3-butadiene (compound (1)). The electrostatic property and the durability of the electrophotographic photoreceptor were estimated and the results are shown in Table 1.

### Comparative Example 1

An electrophotographic photoreceptor was manufactured in the same manner as in Example 1, except that α-type oxotitanyl phthalocyanine (TPL-364, available from Japan Materials, Co., Ltd. was used in the charge generating layer, instead of the μ-oxo-gallium phthalocyanine dimer. The electrostatic property and the durability of the electrophotographic photoreceptor were estimated and the results are shown in Table 1.

### Comparative Example 1

An electrophotographic photoreceptor was manufactured in the same manner as in Example 1, except that α-type oxotitanyl phthalocyanine (TPL-364, available from Japan Materials, Co., Ltd.) was used in the charge generating layer, instead of the μ-oxo-gallium phthalocyanine dimer, and 6 parts by weight of N,N′-bis-(3-methylphenyl)-N,N′-bis(phenyl)benzidine (compound (6)) and 2 parts by weight of N,N,N′,N′-tetrakis(4-methylphenyl)benzidine (compound (7)) were used in the charge transporting layer, instead of 4 parts by weight of 4-dibenzylamino-2-methylbenzaldehydediphenylhydrazone (compound (4)) and 4 parts by weight of 1,1-bis-(p-diethylaminophenyl)-4,4-diphenyl-1,3-butadiene (compound (1)). The electrostatic property and the durability of the electrophotographic photoreceptor were estimated and the results are shown in Table 1.

### Example 7

An electrophotographic photoreceptor was manufactured in the same manner as in Example 1, except that the coating solution for the charge generating layer was used to form the charge generating layer, after having been left in an oven at 30° C. for 1 month. The electrostatic property and the durability of the electrophotographic photoreceptor were estimated and the results are shown in Table 1.

### Example 8

An electrophotographic photoreceptor was manufactured in the same manner as in Example 1, except that the coating solution for the charge generating layer was used to form the charge generating layer, after having been left in an oven at 30° C. for 1 month, and the coating solution for the charge transporting layer obtained in Example 5 was used to form the charge transporting layer. The electrostatic property and the durability of the electrophotographic photoreceptor were estimated and the results are shown in Table 1.

### Comparative Example 3

An electrophotographic photoreceptor was manufactured in the same manner as in Example 1, except that the coating solution for the charge generating layer obtained in Comparative Example 1 was used to form the charge generating layer, after having been left in an oven at 30° C. for 1 month. The electrostatic property and the durability of the electrophotographic photoreceptor were estimated and the results are shown in Table 1.

Measurement of the electrostatic property

The electrostatic property (the electrophotographic property) of each of the electrophotographic photoreceptors manufactured in Examples 1-8 and Comparative Examples 1-3 was measured using an apparatus for estimating the electrostatic property (“PDT-2000”, available from QEA) at 23° C. and a relative humidity of 50%.

Each of the electrophotographic photoreceptors was charged under the condition of a corona voltage of −6.0 kV and a relative speed of the charging device to the photoreceptor being 100 mm/sec. Then, monochromatic light having a wavelength of 780 nm in the range of an exposure energy of 0-2 μJ/cm² was irradiated on the photoreceptor to measure E_{1/2} (μJ/cm²) and E₁₀₀ (μJ/cm²). E_{1/2} (μJ/cm²) denotes an exposure energy when an initial charge potential V₀ (V) becomes V₀/2 (V). E₁₀₀ (μJ/cm²) denotes an exposure energy when V₀ is −100V.

Measurement of the adhesive force

A surface of each of the photoreceptor drums having an area of 10 mm×10 mm was scored to a size of 1 mm×1 mm using a knife and a 3M Scotch® Magic™ Tape (width: ¾ in.) was adhered thereto, and then peeled off in a direction perpendicular to the longitudinal direction of the photoreceptor drum. The number of pieces having the square shape of 1 mm×1 mm, peeled from the photoreceptor surface was counted and the adhesive force of each of the electrophotographic photoreceptors was rated on the basis of the counted number, as follows:
Good adhesive force: 4 or less pieces peeled off
Moderate adhesive force: 5-10 pieces peeled off

Bad adhesive force: 11 or more pieces peeled off

TABLE 1

| | E_{1/2} (μJ/cm²) | E₁₀₀ (μJ/cm²) | Adhesive force |
|---|---|---|---|
| Example 1 | 0.31 | 0.69 | Good |
| Example 2 | 0.28 | 0.52 | Good |
| Example 3 | 0.26 | 0.43 | Good |
| Example 4 | 0.29 | 0.62 | Good |
| Example 5 | 0.26 | 0.61 | Good |
| Example 6 | 0.27 | 0.65 | Good |
| Example 7 | 0.31 | 0.70 | Good |
| Example 8 | 0.26 | 0.50 | Good |
| Comparative | 0.44 | 0.97 | Good |
| Example 1 | | | |
| Comparative | 0.35 | 0.81 | Moderate |
| Example 2 | | | |
| Comparative | 0.46 | 1.20 | Moderate |
| Example 3 | | | |

Referring to Table 1, the electrophotographic photoreceptors using the μ-oxo-gallium phthalocyanine dimer as the CGM, obtained in Examples 1-8, have lower E_{1/2} and E₁₀₀ than the electrophotographic photoreceptors using α-type oxotitanyl phthalocyanine, obtained in Comparative Examples 1-3. Thus, it was confirmed that it is more advantageous to use the μ-oxo-gallium phthalocyanine dimer rather than the α-type oxotitanyl phthalocyanine in a view of the photosensitivity. Particularly, this fact was more clearly confirmed when comparing Example 1 with Comparative Example 1 and Example 5 with Comparative Example 2, in which Example 1 and Comparative Example 1, and Example 5 and Comparative Example 2 are different from each other only in that the μ-oxo-gallium phthalocyanine dimer and the α-type oxotitanyl phthalocyanine were respectively used as the CGM.

When E_{1/2} and E₁₀₀ of the photoreceptor obtained in Example 7 were compared with E_{1/2} and E₁₀₀ of the photoreceptor obtained in Example 1 or when E_{1/2} and E₁₀₀ of the photoreceptor obtained in Example 5 were compared with E_{1/2} and E₁₀₀ of the photoreceptor obtained in Example 8, it was confirmed that although the coating solution for the charge generating layer, using the μ-oxo-gallium phthalocyanine dimer, was used after having been left for a long time, the electrostatic property exhibited little or no decrease. Thus, it was confirmed that the μ-oxo-gallium phthalocyanine dimer has high dispersion stability in the coating solution as well as an excellent electrostatic property.

When E_{1/2} and E₁₀₀ of the photoreceptor obtained in Example 1 were compared with E_{1/2} and E₁₀₀ of the photoreceptor obtained in Comparative Example 3, it was confirmed that the α-type oxotitanyl phthalocyanine has a lower dispersion stability in the coating solution as well as worse electrostatic properties than the μ-oxo-gallium phthalocyanine dimer.

The photoreceptors in the Examples and Comparative Examples generally exhibited good adhesive forces. However, the photoreceptor obtained in Comparative Example 3, in which the coating solution for the charge generating layer had been stored for a long time, exhibited a decreased adhesive force.

According to the present invention, an electrophotographic photoreceptor contains μ-oxo-gallium phthalocyanine dimer, and thus, it has an excellent electrostatic property and also has high interlayer adhesive force and resistance to abrasion in combination with a polycarbonate-Z binder, a phosphate compound and/or a phosphine oxide compound, and a silicone oil. Thus, by using the electrophotographic photoreceptor, an electrophotographic imaging apparatus, for example, an electrophotographic printer, a facsimile machine, a photocopier, or a flutter, can have a reduced change in image quality with time after a long time use, fewer image defects due to peeling or abrasion of the electrophotographic photoreceptor, and excellent performance. Furthermore, the μ-oxo-gallium phthalocyanine dimer has high dispersion stability in the coating solution, thereby reducing the production costs of the electrophotographic photoreceptor.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophotographic photoreceptor comprising:
an electrically conductive substrate;
a charge generating layer formed on the electrically conductive substrate and comprising μ-oxo-gallium phthalocyanine dimer as a charge generating material dispersed in a binder resin; and
a charge transporting layer formed on the charge generating layer, the charge transporting layer comprising a charge transporting material dispersed in a binder resin, the charge transporting material being selected from the group consisting of (1) a combination of a butadiene-based amine compound and a hydrazone compound and (2) a combination of a first benzidine compound and a second benzidine compound, wherein the amount of the charge transporting material is 5-200 parts by weight based on 100 parts by weight of the binder resin of the charge transporting layer.

2. The electrophotographic photoreceptor of claim 1, wherein the charge transporting layer further comprises 0.01-10 parts by weight of a phosphate compound, a phosphine oxide compound, or mixture thereof based on 100 parts by weight of the binder resin of the charge transporting layer, and 0.01-1 parts by weight of silicone oil based on 100 parts by weight of the binder resin of the charge transporting layer.

3. The electrophotographic photoreceptor of claim 1, wherein a weight mixing ratio of the butadiene-based amine compound:the hydrazone compound is 100:5-250 and a weight mixing ratio of the first benzidine compound:the second benzidine compound is 100:5-300.

4. The electrophotographic photoreceptor of claim 1, wherein the first benzidine compound and the second benzidine compound are two different benzidine derivatives selected from the group consisting of N,N′-bis-(3-methylphenyl)-N,N′-bis(phenyl)benzidine, N,N,N′,N′-tetrakis(3-methylphenyl)benzidine, N,N,N′,N′-tetrakis(4-methylphenyl)benzidine, N,N′-di(naphthalene-1-yl)-N,N′-di(4-methylphenyl)benzidine, and N,N′-di(naphthalene-2-yl)-N ,N′-di(3-methylphenyl)benzidine.

5. The electrophotographic photoreceptor of claim 1, wherein the electrically conductive substrate is selected from the group consisting of a metal substrate having an alumite layer formed on its surface; a metal substrate having an undercoat layer comprising an inorganic oxide dispersed in a binder resin; and a metal substrate having an alumite layer and an undercoat layer comprising an inorganic oxide dispersed in a binder resin, sequentially formed on its surface.

6. The electrophotographic photoreceptor of claim 1, wherein the μ-oxo-gallium phthalocyanine dimer has diffraction peaks at Bragg angles (2θ±0.2°) of about 7.4°, 9.9°, 12.5°, 13.0°, 15.0°, 16.2°, 17.5°, 17.9°, 18.6°, 22.2°, 24.1°, 25.2°, 25.9°, 26.9°, 28.3°, and 29.9° and has the strongest diffraction peak at a Bragg angle of about 7.4°.

7. The electrophotographic photoreceptor of claim 1, wherein the binder resin of the charge generating layer comprises polyvinyl butyral and the binder resin of the charge transporting layer comprises polycarbonate-Z.

8. An electrophotographic cartridge comprising:
an electrophotographic photoreceptor comprising:
an electrically conductive substrate;
a charge generating layer formed on the electrically conductive substrate and comprising μ-oxo-gallium phthalocyanine dimer as a charge generating material dispersed in a binder resin; and
a charge transporting layer formed on the charge generating layer, the charge transporting layer comprising a charge transporting material dispersed or dissolved in a binder resin, the charge transporting material being selected from the group consisting of (1) a combination of a butadiene-based amine compound and a hydrazone compound and (2) a combination of a first benzidine compound and a second benzidine compound, wherein the amount of the charge transporting material is 5-200 parts by weight based on 100 parts by weight of the binder resin of the charge transporting layer; and
at least one device selected from the group consisting of:
a charging device charging the electrophotographic photoreceptor;
a developing device developing an electrostatic latent image formed on the electrophotographic photoreceptor; and
a cleaning device cleaning a surface of the electrophotographic photoreceptor,
the electrophotographic cartridge being attachable to or detachable from an imaging apparatus.

9. An electrophotographic imaging apparatus comprising:
an electrophotographic photoreceptor comprising:
an electrically conductive substrate;
a charge generating layer formed on the electrically conductive substrate and comprising p-oxo-gallium phthalocyanine dimer as a charge generating material dispersed in a binder resin; and
a charge transporting layer formed on the charge generating layer, the charge transporting layer comprising a charge transporting material dispersed or dissolved in a binder resin, the charge transporting material being selected from the group consisting of (1) a combination of a butadiene-based amine compound and a hydrazone compound and (2) a combination of a first benzidine compound and a second benzidine compound, wherein the amount of the charge transporting material is 5-200 parts by weight based on 100 parts by weight of the binder resin of the charge transporting layer;
a charging device for charging the electrophotographic photoreceptor;
an imageforming light irradiating device for irradiating light onto the charged electrophotographic photoreceptor to form an electrostatic latent image on the electrophotographic photoreceptor;
a developing unit for developing the electrostatic latent image with a toner to form a toner image on the electrophotographic photoreceptor; and
a transfer device for transferring the toner image onto a receptor.

10. The electrophotographic imaging apparatus of claim 9, wherein the charge transporting layer further comprises 0.01-10 parts by weight of a phosphate compound, a phosphine oxide compound, or a mixture thereof based on 100 parts by weight of the binder resin of the charge transporting layer, and 0.01-1 parts by weight of silicone oil based on 100 parts by weight of the binder resin of the charge transporting layer.

11. The electrophotographic imaging apparatus of claim 9, wherein a weight mixing ratio of the butadiene-based amine compound:the hydrazone compound is 100:5-250 and a weight mixing ratio of the first benzidine compound:the second benzidine compound is 100:5-300.

12. The electrophotographic imaging apparatus of claim 9, wherein the first benzidine compound and the second benzidine compound are two different benzidine derivatives selected from the group consisting of N,N′-bis-(3-methylphenyl)-N,N′-bis(phenyl)benzidine, N,N,N′,N′-tetrakis(3-methylphenyl)benzidine, N,N,N′,N′-tetrakis(4-methylphenyl)benzidine, N,N′-di(naphthalene-1-yl)-N,N′-di(4-methylphenyl)benzidine, and N,N′-di(naphthalene-2-yl)-N,N′-di(3-methylphenyl)benzidine.

13. The electrophotographic imaging apparatus of claim 9, wherein the electrically conductive substrate is selected from the group consisting of a metal substrate having an alumite layer formed on its surface; a metal substrate having an undercoat layer comprising an inorganic oxide dispersed in a binder resin; and a metal substrate having an alumite layer and an undercoat layer comprising an inorganic oxide dispersed in a binder resin, sequentially formed on its surface.

14. The electrophotographic imaging apparatus of claim 9, wherein the μ-oxo-gallium phthalocyanine dimer has diffraction peaks at Bragg angles (2θ±0.2°) of about 7.4°, 9.9°, 12.5°, 13.0°, 15.0°, 16.2°, 17.5°, 17.9°, 18.6°, 22.2°, 24.1°, 25.2°, 25.9°, 26.9°, 28.3°, and 29.9° and has the strongest diffraction peak at a Bragg angle of about 7.4°.

15. The electrophotographic imaging apparatus of claim 9, wherein the binder resin of the charge generating layer comprises polyvinyl butyral and the binder resin of the charge transporting layer comprises polycarbonate-Z.
